(19) United States
(12) Patent Application Publication
(10) Pub. No.: US 2024/0347750 A1
(43) Pub. Date: Oct. 17, 2024

(54) METHOD AND CONTROL SYSTEM FOR MODULAR ELECTROLYSIS CELL ARRANGEMENT

(71) Applicant: DUG Technology (Australia) Pty Ltd., West Perth (AU)

(72) Inventors: Mark Lommers, Sherton Park (AU); Ross Sciarrone, Wembley Downs (AU)

(21) Appl. No.: 18/634,091

(22) Filed: Apr. 12, 2024

Related U.S. Application Data
(63) Continuation of application No. PCT/US2022/046540, filed on Oct. 13, 2022.
(60) Provisional application No. 63/262,454, filed on Oct. 13, 2021.

(51) Int. Cl. H01M 8/04746; H01M 8/04537; H01M 8/0656

(52) U.S. Cl. CPC H01M 8/04753; H01M 8/04544; H01M 8/0656

(57) ABSTRACT

A control system for operating a modular arrangement of electrolysis cells under variable input voltage conditions, such as those from renewable energy sources, to optimize operation by reducing under and over potential of cells. Energy supply and electrolyte flow to cells or groups of cells is interrupted or resumed in response to available electrical potential and the optimal electrical potential required by active cells.

### CROSS REFERENCE TO RELATED APPLICATIONS

Continuation of International Application No. PCT/US2022/046540 filed on Oct. 13, 2022. Priority is claimed from U.S. Provisional Application No. 63/262,454 filed on Oct. 13, 2021. Each of the foregoing applications is incorporated herein by reference in its entirety.

### STATEMENT REGARDING FEDERALLY SPONSORED RESEARCH OR DEVELOPMENT

Not Applicable

### NAMES OF THE PARTIES TO A JOINT RESEARCH AGREEMENT

Not Applicable.

### BACKGROUND

This disclosure relates to the field of process controls that are designed for complex systems having both electrical and mechanical components. More specifically, the disclosure relates to control systems for the management of electrolysis equipment that is coupled to a variable power source, such as a renewable energy source.

Modern electricity generation is a complex mix of various technologies. Dispatchable generation, such as thermal sourced coal and gas powered, or hydropower generation, may be complemented by non-dispatchable sources such as solar (photovoltaic and/or solar-thermal) or wind power. These non-dispatchable energy sources are intermittent by definition, exhibiting varying power output relative to the instantaneous local weather conditions, time of day and time of year.

To continue reducing the possible impact on the environment, power generators are moving towards higher levels of renewable generation and reducing or phasing out the use of traditional fossil fuel energy sources. Compared to dispatchable generation, non-dispatchable generation sources, such as solar power, exhibit greater intermittency of power availability due to the nature of their method of harnessing energy from the environment. For these reasons, it is impractical to rely on renewable sources for baseload electricity without a “load firming” storage system which buffers between the generator and the consumer to regulate the supply and ensures consistent power availability.

Additionally, efforts to provide “off grid” carbon-free electric power systems are increasingly reliant on localized solar generation systems to provide renewable energy supply.

Electro-chemical batteries have traditionally been used to provide load firming of variable power generation sources. Disadvantages of electro-chemical batteries include high capital cost, environmental impact of sourcing the raw materials for new batteries, low energy density as contrasted with combustion or catalysis of combustible materials, and substantial safety issues associated with the operation of large battery banks. For these reasons, alternative energy storage technologies, such as hydrogen gas storage, are becoming more widely used. Hydrogen gas storage technology provides an environmentally friendly alternative to traditional electro-chemical batteries.

There are multiple methods for generating hydrogen gas from various feedstocks. The method relevant to the present disclosure is the electrolysis of water. Methods for the production of hydrogen gas by water electrolysis are well-established. Industrial scale water electrolysis equipment is widely available, and the technology is mature.

One solution to stabilize the variable nature of non-dispatchable energy generators is to couple them to hydrogen gas generation/storage systems such as the above-described electrolysis equipment in a simple, reliable, and efficient manner. The hydrogen gas generation system acts as a buffer to the non-dispatchable energy source, absorbing excess energy when supply exceeds demand and converting the excess energy to hydrogen gas. Conversely, when electric energy demand exceeds supply, the hydrogen gas may be processed to generate electricity (e.g., via a fuel cell) and thereby serve the load. Such hydrogen-based buffer systems can provide consistent, reliable electricity to end users in an environmentally friendly manner.

The electrolysis systems used to generate hydrogen gas (as contemplated above) are sensitive to the input voltage to each electrolysis cell, affecting both the purity of generated gas and the efficiency of production. Operation during under-voltage conditions (when marginally insufficient voltage has been applied to the electrolysis cell) results in “poisoned” hydrogen production, where unwanted oxygen gas may be generated, affecting the purity of the hydrogen gas product stream. Over-voltage conditions (when the voltage applied to the electrolysis cell substantially exceeds the required activation voltage) result in poor cell efficiency due to internal heating of the cell.

Non-dispatchable energy sources, such as solar power, have constantly varying outputs and do not provide the stable voltage required to efficiently run an electrolysis system without intervention. Thus, there is a continued need for buffers to be used in connection with non-dispatchable electric generating sources.

### SUMMARY

The current disclosure presents a control system for the staged operation of a modular system of electrolyzers, allowing reliable and efficient operation by ensuring the optimal aggregate voltage required by the cells in such system is consistently matched with a variable input voltage, such as that provided by non-dispatchable electric generating systems such as solar and wind generating systems.

One aspect of the present disclosure is a method for operating an electrolyzer system comprising a plurality of electrolysis cells. A method according to this aspect of the disclosure includes the method comprising measuring a voltage generated by an electric power source and comparing the measured voltage to an optimum electrolyzer voltage. The optimum electrolyzer voltage comprises a product of an operating voltage for one of the plurality of electrolysis cells and a number of the plurality of electrolysis cells electrically connected to the electric power source. When the measured voltage exceeds the optimum electrolyzer voltage, at least one additional electrolysis cell is connected to the electric power source. When the measured voltage falls below the optimum electrolyzer voltage, at least one electrolysis cell is disconnected from the electric power source.

Some embodiments further comprise that when the measured voltage exceeds the optimum electrolyzer voltage, the at least one additional electrolysis cell is hydraulically connected to a source of electrolyte solution and to a produced gas header. When the measured voltage falls below the optimum electrolyzer voltage, at least one electrolysis cell is isolated from the source of electrolyte solution and from the produced gas header.

Some embodiments further comprise that when the measured voltage exceeds the optimum electrolyzer voltage, the at least one additional electrolysis cell is hydraulically connected to either a waste line or to a supplemental gas product line for a predetermined period of time prior to connecting the at least one additional electrolysis cell to the produced gas header.

Some embodiments further comprise charging an electric energy storage device when the measured voltage exceeds the optimum electrolyzer voltage by less than an amount at which the at least one additional electrolysis cell is connected, and discharging the electric energy storage device when the measured voltage falls below the optimum electrolyzer voltage by less than the amount at which the at least one electrolysis cell is disconnected.

In some embodiments, the electric power source is a variable output electric power source.

In some embodiments, the electric power source comprises at least one of a photovoltaic generator, a solar thermal generator and a wind powered generator.

An energy storage system for use with a variable output electric power source according to another aspect of the present disclosure includes a plurality of electrolysis cells, each comprising an electrolyte solution inlet, valves operable to connect a hydrogen gas outlet of each electrolysis cell to a product gas line, and switches operable to electrically connect the cell to the variable output electric power source. A voltage measuring circuit is connected to the variable output electric power source. A controller is in signal communication with the voltage measuring circuit, the valves and the switches. The controller is arranged to calculate a number of the plurality of electrolysis cells to activate or deactivate in response to a difference between a measured voltage and an optimum voltage. The controller is arranged to operate the switches and the valves for the number of the plurality of electrolysis cells to be activated or deactivated in response to the measured voltage.

In some embodiments, the controller is arranged to operate the valves to connect hydrogen gas outlet of each of the number of electrolysis cells being activated to a waste gas line or a supplemental gas product line for a predetermined period of time prior to operating the valves to connect the hydrogen outlet of each of the number of electrolysis cells to the product gas line.

Some embodiments further comprise an electric energy storage device electrically connected to the variable output electric power source and an electrical load. The electric energy storage device is electrically connected to the plurality of electrolysis cells, wherein the electric energy storage device is charged when the measured voltage exceeds the optimum electrolyzer voltage by less than a predetermined difference at which the controller operates to connect the at least one additional electrolysis cell. The electric energy storage device is discharged when the measured voltage falls below the optimum electrolyzer voltage by less than amount at which the controller operates to disconnect the at least one electrolysis cell.

In some embodiments, the electric energy storage device comprises a battery or a capacitor.

In some embodiments, the battery comprises an electrochemical battery.

Other aspects and possible advantages will be apparent from the description and claims that follow.

### BRIEF DESCRIPTION OF THE DRAWINGS

FIG. 1 shows a graph of electrolysis cell efficiency with respect to voltage applied across the cell.

FIG. 2 shows a flow chart of a method for operating a number of electrolyzer cells in response to output of a variable output electric power source.

FIG. 3 shows a flow chart of operation of a control system according to the present disclosure.

FIG. 4 shows an example embodiment of valves used to hydraulically connect and disconnect electrolysis cells to implement a purge of the cells on start-up.

### DETAILED DESCRIPTION

The present disclosure provides a method and a system to control a plurality of electrolysis cells producing hydrogen to enable optimal operation given an electric power source with varying output properties.

The criteria applied are the control of a hydrogen production system and its interface with a variable output electric power source to ensure the voltage applied to each electrolysis cell in the system remains within an ideal range to maintain optimal operation of the electrolysis cells. “Variable” as that term applies to an electric power source in the present disclosure means that the output of the electric power source is a result of energy input that is not subject to human control, e.g., wind and/or solar powered (photovoltaic or thermal) electric power generators.

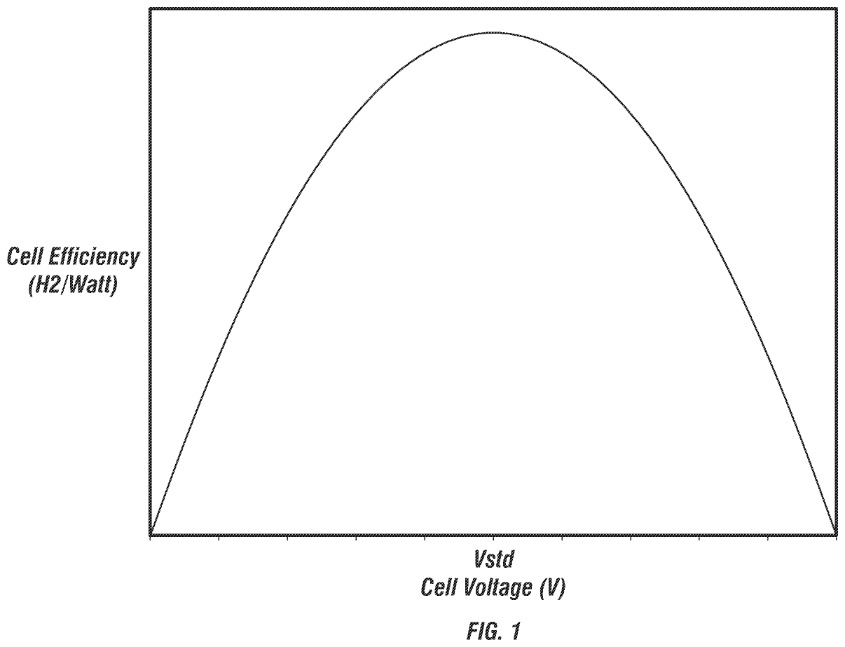

FIG. 1 shows a representation of the “efficiency curve” of an example electrolysis cell with respect to voltage applied to the electrolysis cell. Efficiency is measured as rate of hydrogen gas produced per unit of electric power input to the electrolysis cell. Lower than optimum applied voltage results in electrolysis cell inefficiency due to production of unwanted gases, such as oxygen, contaminating the product gas (hydrogen) stream. Higher than optimum applied voltage reduces production efficiency due to excessive internal cell heating, resulting in energy waste.

The present disclosure provides a control system, which may be implemented as a computer program residing on a suitable microcomputer, processor, programmable gate array, programmable logic controller or any other suitable digital processor. The computer program may be designed to obtain the criteria outlined above. The control system, e.g., a computer algorithm implemented on any of the foregoing processors or controllers (hereinafter “controller” for convenience), may be designed to operate an electrolysis system of at least one electrolysis cell, however the principles presented here may be applied to any number of cells in any particular embodiment of an electrolysis system.

The at least one electrolysis cell may be controllably electrically connected to the electric power source by suitable switches operated by the controller. The at least one electrolysis cell may be controllably hydraulically coupled to a product gas line or stream by suitable valve(s), such as electric solenoid operated valves, which may also be operated by the controller. By suitably operating the switches and valves to connect and disconnect the at least one electrolysis cell when certain criterial are met, the effective connected electrolysis cell capacity of the electrolysis system may be controlled dynamically in response to a varying input voltage from the variable electric power source, thereby optimizing the electrolysis system operation.

The electrolysis system disclosed herein is designed to account for various operational considerations affecting the performance of the individual electrolysis cells in the electrolysis system, including response times for shutdown and start-up of electrolysis cells, and hydrogen gas purity considerations.

The functionality of the controller, and its interfaces with the electrolysis cell(s) and the variable electric power source may be described as follows. The primary input to the controller is the measured available electric supply voltage from the variable electric power source. The controller evaluates the measured voltage, numbers of electrolysis cells in operation and not in operation, and executes instructions to connect or disconnect one or more electrolysis cells both hydraulically and electrically from the active portion of the electrolysis system based on the measured available electric supply voltage.

The electrolysis cells in a multiple cell electrolysis system may be arranged in electrical groups in a manner such that the supply voltage applied to each group is split evenly between the cells. Each electrolysis cell has a known preferred operating voltage range, as explained in part with reference to FIG. 1. Such operating voltage range is programmed into the controller. Each cell is coupled to the controller by one or more electrical switches and suitable valves. The controller may act on these switches and valves to connect/disconnect each individual electrolyzer cell from the electrolysis system as required.

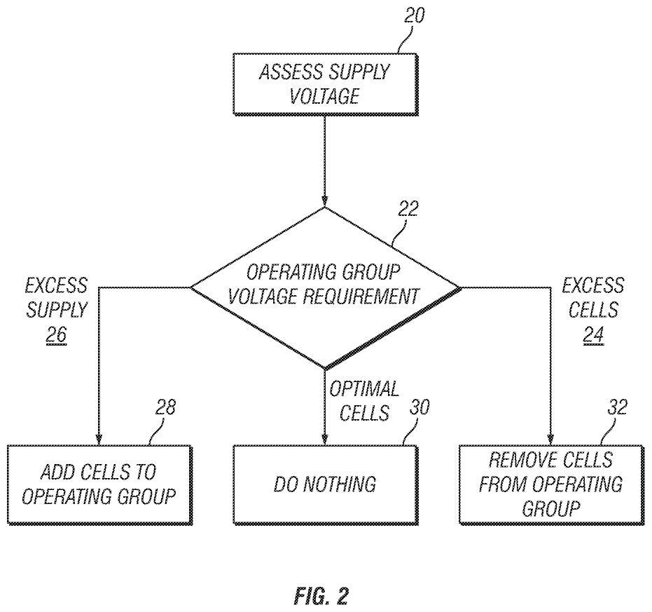

In an example embodiment, as shown in FIG. 2, the electric supply voltage from the variable electric power source is applied to at least one electrolysis cell. When more than one electrolysis cell, which in the present example embodiment may each be designed to have the same cell resistance and gas output rate, is connected to the electrolysis system so as to be active, the electric supply voltage may be split evenly between the connected cells (as they all have the same electrical resistance). The connected cells may be arranged in one or more operating groups. The controller is designed to control the number of connected and operating cells so that the individual cell voltages stay within a specified range, thus promoting optimum performance of the connected cells.

The electric supply voltage is measured at 20 and is compared at 22 to the required voltage for each cell in all the operating cells in the operating group. As the supply voltage rises, the individual cell voltages will also rise. Once the measured voltage and thereby the individual cell voltages exceed the allowable range at 26, the controller will act upon the above described valves and switches to connect at least one idle cell, at 28, to put such cell into operation. If at least one cell is already in operation, the activated idle cell will then become part of the operating group of cells and draw current from the variable electric power source accordingly. The addition of another cell or cells to the operating group effectively reduces each individual cell voltage by sharing the available voltage to a larger group of cells. Similarly, when the measured voltage falls, the controller will act in the opposite manner, that is, to disconnect one or more cells from the set or operating group of actively operating cells. When the measured voltage falls below the acceptable range in respect of the number of actively operating cells, at 24, the controller will act upon valves and switches to disconnect at least one operating cell from the operating group at 32. The removal of at least one cell from the operating group effectively increases each individual cell voltage by sharing the available voltage to a smaller group of actively operating cells. When the measured voltage is correct for the number of operating cells as shown at 30, the controller does nothing with reference to the number of operating cells in the operating group.

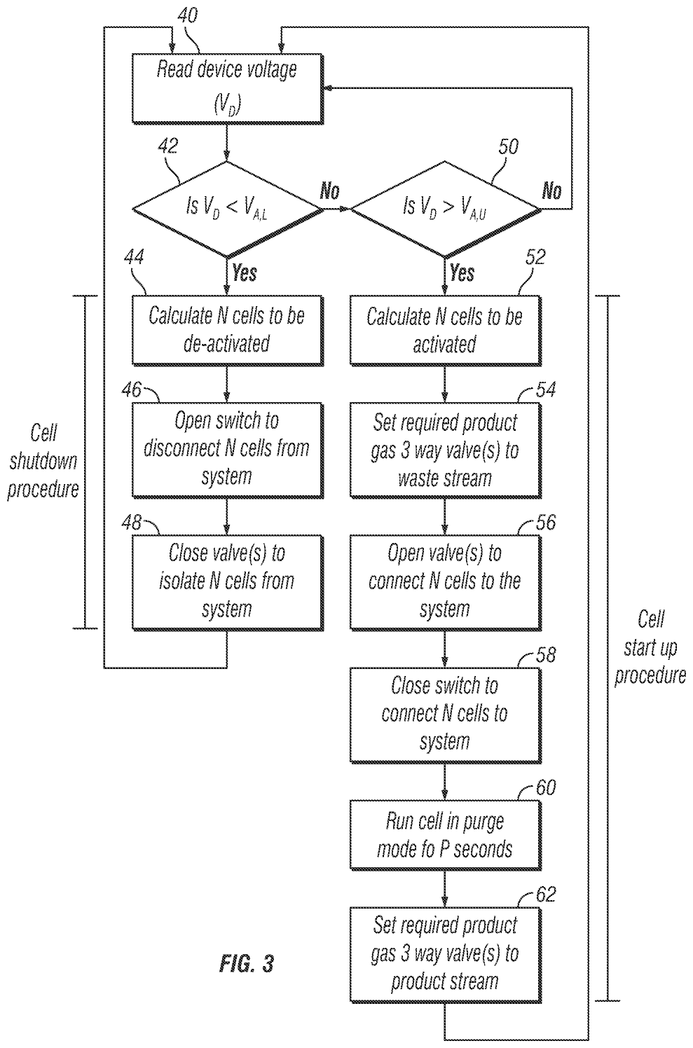

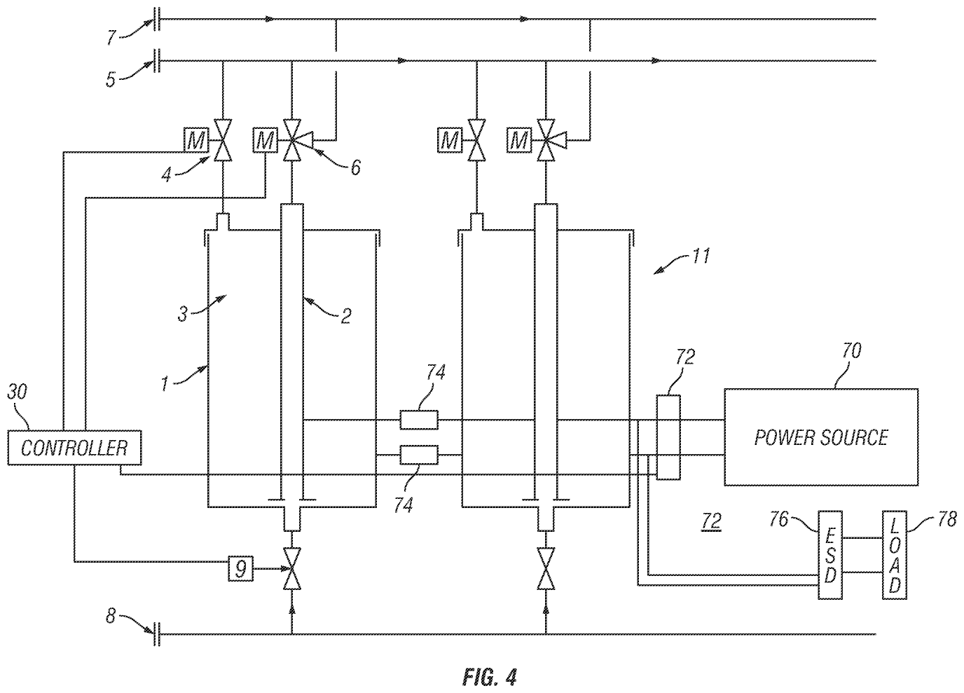

The basic operation of the control system is shown in flow chart form in FIG. 3. Voltage across the electrolysis cell system from the variable electric power source is measured at 40. An example embodiment of measuring voltage of the variable electric power source and communicating measurements to the controller is shown in FIG. 4. Still referring to FIG. 3, the measured voltage may be referred to as the device voltage VD. At 42, if the measured voltage is lower than the value of or the range of allowable system voltages (VAL) then a number of cells to disconnect from the system is calculated at 44. At 46, an electrical switch that connects electrical power to each of the one or more selected cells for shutdown is opened, stopping flow of current through such cell(s). Such switch(es) may be relays, electromechanical switches such as solenoid operated switches, solid state switches or any other suitable controllable current interrupting device. An example embodiment of such switches and their operation by the controller may be observed in FIG. 4. Still referring to FIG. 4, at 48, one or more respective valves controlling the supply of aqueous electrolyte solution to each respective cell may be closed to stop flow of electrolyte solution to the electrically disconnected cell(s). Also at 48, one or more respective valves controlling movement of produced gases from the one or more disconnected cells may be closed.

The voltage may be measured, again at 40, at any suitable predetermined time interval or continuously.

At 50, if the measured voltage is greater than the value of or the range of allowable system voltages (V_{AU}) then a number of cells to activate within the system is calculated at 52. At 54, one or more valves for each cell to be activated may be operated to direct produced gas from the to-be-activated cell(s) to a waste line. At 56, valve(s) to connect the one or more cells to flow of electrolyte solution may be operated to enable such flow to the one or more cells. At 58, suitable switches to the one or more cells may be closed to begin gas generation from such one or more cells. At 60, the one or more cells may be operated in “purge” mode for a predetermined time interval to enable clearing of contaminated gas from the produced gas stream of such one or more cells. At 62, when the purge mode time interval has ended, the one or more valves may be operated, at 62, to direct produced gases to the produced gas or product stream.

Any particular embodiment of a system and method according to the present disclosure may comprise connecting and disconnecting multiple-cell groups of electrolyzer cells in response to measured system supply voltage, as opposed to or in conjunction with switching individual cells within an operating group. The processes for electrical and mechanical isolation in the present example embodiment follow the same principles as the embodiment explained with reference to FIG. 3, although the details of how the switching and valving functions are obtained may be different for different specific implementations. These details are not critical to the conceptual operation of the control system.

When starting at least one electrolysis cell, and as explained with reference to FIG. 3, consideration may be given to the purity of the produced gases, in particular the hydrogen gas. Very high purity levels (>99%) are required for the product gas to be useful in downstream processes, such as combustion or catalysed electric power generation (fuel cell). Gas purity is most likely to be unstable during cell start-up due to contaminant gas production during start-up.

To address the problem of contamination in gas produced at cell start-up, the control system may include a series of actions and time delays which operate when at least one cell is started, that is, the purge mode explained with reference to FIG. 3. The actions and time delays serve to purge the system of contaminants. The purge mode may function as follows and as shown in FIG. 4.

Each electrolysis cell 1 has at least one product (H₂) gas stream 2 and a waste or supplemental product (O₂) gas stream 3. The waste gas stream 3 may be connected through a valve 4, e.g., a 2-way valve to a waste stream header 5. The valve 4 may be a motor operated valve, a solenoid operated valve or use any other suitable form of power operated actuator M such that the control system, e.g., implemented in a controller 30, may generate suitable control signals to operate the valve 4 and other valves for each cell or group of cells. The product gas stream 2 may be connected via a valve 6, e.g., a 3-way valve, selectably to either a waste stream header 5 or to a product stream header 7. The 3-way valve may also have a power operated actuator M, such as an electric motor operated or solenoid operated actuator. While a 3-way valve is shown, it will be appreciated that the same function may be provided by two, 2-way valves making corresponding connections as the illustrated 3-way valve. An electrolyte inlet valve 9 may be opened to enable movement of electrolyte solution into the cell 1 from a return electrolyte stream header 8 when the cell is to be activated. The inlet valve 9 may be otherwise closed.

The controller 30 may be implemented using any suitable electronic control device, e.g., a microcomputer, microprocessor, field programmable gate array, application specific integrated circuit, or any combination of analog controls that can perform the functions and operations described herein.

When a cell 1 or a group of cells is added to an operating group, the 3-way valve 6 may be closed to the product stream header 7 and open to the waste stream header 5. Hence any ‘product gas’ produced by the cell 1 and discharging into the product gas stream 2, which may or may not include contaminants, will be diverted to the waste stream header 5. This will ensure the lower-quality gas produced at start up is not sent to the product stream header 7.

After a predetermined period of time, which may be defined in control system software for computer implemented versions of a control system, the purge cycle completes. The 3-way valve 6 may then be closed to the waste stream header 5 and opened to the product stream header 7, thereby directing the product gas stream 2 to the product stream header 7.

During operation of the electrolyzer system, electrolyte may be returned to the cell(s) via the return electrolyte stream header 8. One or more additional cells 11, etc. may each comprise similar control features to enable corresponding operation.

FIG. 4 also shows a schematic illustration of a possible implementation of electrolysis cell switching according to the present disclosure. A variable electric power source 70 as explained above may be electrically connected to one or more electrolysis cells (e.g., at 11) either directly as shown or through one or more switches 74. The one or more switches 74 may be operated by the controller 30, or another controller (not shown but explained to provide understanding that the valves 4, 6, 9 need not be operated by the same physical device as the control for electrical switches) implemented as explained elsewhere herein. A voltage measuring circuit 72 may be in electrical communication with an output of the variable electric power source 70, and communicate measurements of voltage to the controller 30. The controller 30 may implement the above-described procedure to operate the switches 74 so as to electrically connect and disconnect at least one electrolysis cell 1 as explained with reference to FIGS. 2 and 3.

A control system according to the present disclosure can be implemented on individual electrolyzer cells, or complete cell groups, and allows for efficient, automated start-up and shut down of cells as required.

The control system, if implemented in a computer or similar programmable device, contains logic designed to evaluate the number of cells to be included in any operating group based on the input voltage to the system. The controller may measure the input voltage and calculate the difference between the measured voltage and the optimal voltage of the operating cell group (the product of the number of active cells and the predetermined optimum cell voltage). This difference is divided by the standard cell voltage to evaluate the number of cells which must be added to or removed from the operating group to return the average cell voltage to its optimal value:

### Example

Input voltage=24 V
Standard cell voltage=2 V
No. of cells in operational group=10

$$Optimal voltage = Std . cell voltage \times No . of active cells = 2 \times 10 = 20 V$$

$$Voltage difference = input voltage - optimal voltage = 24 - 20 = 4 V$$

$$Number of cells to activate = ( voltage difference ) / ( std . cell voltage ) = 4 / 2 = 2 cells$$

Note that a positive voltage difference (measured voltage above optimum voltage) results in one or more cells being connected to the system (turned on), a negative voltage difference results in one or more cells being disconnected from the system (turned off).

Optimum performance of the entire electrolyzer system may be obtained when the operating group of the electrolysis system is dynamically sized to align well with the real-time input voltage from the electric power source. In this way, the optimum point of operation is when the voltage supplied and the number of operating cells in the electrolysis system are balanced with respect to available and required applied operating voltage. This results in the control system being idle when the system is functioning at optimal point of operation, and only intervening when a sub-optimal operating condition is detected (i.e., reduced or increased input voltage).

Still referring to FIG. 4, another embodiment of an electrolyzer system according to the present disclosure includes a dynamic energy storage system (DESS), comprising an electric energy storage device 76 such as a battery (e.g., an electrochemical battery such as lead-acid or other rechargeable type) or capacitor, to ensure smooth operation of the control system (e.g., controller 30 in FIG. 4) allowing the switching time required to connect and disconnect at least one electrolysis cell from the system to be buffered. The DESS may be sized to match the cycle time required to add at least one cell, or for cells switched in groups a group of cells, to the operating group allowing a greater optimal range of operation for the system. The DESS may be connected to the combined power output of the electrolysis cells. Charging of the DESS will occur where available supply voltage exceeds the optimal voltage requirement of the operational cell group (the then-operating electrolysis cells in combination) but is less than that required to add at least one cell to the operational cell group. Discharging of the DESS will occur where optimal voltage requirement of the operating cell group exceeds supply voltage prior to disconnecting at least one cell from the operating group. Connection of the system of FIG. 4 may be to any suitable electrical load 78, wherein the electrolysis cells and control system according to the present disclosure, including the DESS may provide a suitable buffer between the variable electric power source and the load 78.

An electrolysis cell control system and method according to the present disclosure may improve electrolysis cell operating efficiency and purity of produced gases when electrolysis cells are connected to a variable output electric generating source such as wind powered generators or solar power generators.

In light of the principles and example embodiments described and illustrated herein, it will be recognized that the example embodiments can be modified in arrangement and detail without departing from such principles. The foregoing discussion has focused on specific embodiments, but other configurations are also contemplated. In particular, even though expressions such as in “an embodiment,” or the like are used herein, these phrases are meant to generally reference embodiment possibilities, and are not intended to limit the disclosure to particular embodiment configurations. As used herein, these terms may reference the same or different embodiments that are combinable into other embodiments. As a rule, any embodiment referenced herein is freely combinable with any one or more of the other embodiments referenced herein, and any number of features of different embodiments are combinable with one another, unless indicated otherwise. Although only a few examples have been described in detail above, those skilled in the art will readily appreciate that many modifications are possible within the scope of the described examples. Accordingly, all such modifications are intended to be included within the scope of this disclosure as defined in the following claims.

What is claimed is:

1. A method for operating an electrolyzer system comprising a plurality of electrolysis cells, the method comprising:
measuring a voltage generated by an electric power source;
comparing the measured voltage to an optimum electrolyzer voltage, the optimum electrolyzer voltage comprising a product of an operating voltage for one of the plurality of electrolysis cells and a number of the plurality of electrolysis cells electrically connected to the electric power source;
when the measured voltage exceeds the optimum electrolyzer voltage, electrically connecting at least one additional electrolysis cell to the electric power source; and
when the measured voltage falls below the optimum electrolyzer voltage, electrically disconnecting at least one electrolysis cell from the electric power source.

2. The method of claim 1 further comprising:
when the measured voltage exceeds the optimum electrolyzer voltage, hydraulically connecting the at least one additional electrolysis cell to a source of electrolyte solution and to a produced gas header; and
when the measured voltage falls below the optimum electrolyzer voltage, hydraulically isolating the at least one electrolysis cell from the source of electrolyte solution and from the produced gas header.

3. The method of claim 1 further comprising, when the measured voltage exceeds the optimum electrolyzer voltage, hydraulically connecting the at least one additional electrolysis cell to either a waste line or to a supplemental gas product line for a predetermined period of time prior to the connecting the at least one additional electrolysis cell to the produced gas header.

4. The method of claim 1 further comprising charging an electric energy storage device when the measured voltage exceeds the optimum electrolyzer voltage by less than an amount at which the at least one additional electrolysis cell is connected to the electric power source, and discharging the electric energy storage device when the measured voltage falls below the optimum electrolyzer voltage by less than an amount at which the at least one electrolysis cell is disconnected from the electric power source.

5. The method of claim 1 wherein the electric power source is a variable output electric power source.

6. The method of claim 5 wherein the electric power source comprises at least one of a photovoltaic generator, a solar thermal generator and a wind powered generator.

7. An energy storage system for use with a variable output electric power source, comprising:
a plurality of electrolysis cells, each comprising an electrolyte solution inlet, valves operable to connect a hydrogen gas outlet of each electrolysis cell to a product gas line, and switches operable to electrically connect the cell to the variable output electric power source;
a voltage measuring circuit connected to the variable output electric power source; and
a controller in signal communication with the voltage measuring circuit, the valves and the switches, the controller operable to calculate a number of the plurality of electrolysis cells to activate or deactivate in response to a difference between a measured voltage and an optimum voltage, the controller arranged to operate the switches and the valves for the number of the plurality of electrolysis cells in response to the measured voltage.

8. The system of claim 7 wherein the controller is arranged to operate the valves to connect hydrogen gas outlet of each of the number of electrolysis cells being activated to a waste gas line or a supplemental gas product line for a predetermined period of time prior to operating the valves to connect the hydrogen outlet of each of the number of electrolysis cells to the product gas line.

9. The system of claim 8 further comprising an electric energy storage device electrically connected to the variable output electric power source and an electrical load, the electric energy storage device electrically connected to the plurality of electrolysis cells, wherein the electric energy storage device is charged when the measured voltage exceeds the optimum electrolyzer voltage by less than a predetermined difference at which the controller operates to connect the at least one additional electrolysis cell, the electric energy storage device discharged when the measured voltage falls below the optimum electrolyzer voltage by less than amount at which the controller operates to disconnect the at least one electrolysis cell.

10. The system of claim 9 wherein the electric energy storage device comprises a battery or a capacitor.

11. The system of claim 10 wherein the battery comprises an electrochemical battery.
